(19) United States
(12) Patent Application Publication
(10) Pub. No.: US 2019/0041997 A1
(43) Pub. Date: Feb. 7, 2019

(54) POINTER CONTROL IN A HANDHELD COMPUTER BY WAY OF HID COMMANDS

(71) Applicant: LIGHT WAVE TECHNOLOGY INC., St-Laurent (CA)

(72) Inventors: Jack WISNIA, Dollard-Des Ormeaux (CA); Feng DU, Kirkland (CA)

(21) Appl. No.: 16/084,732

(22) PCT Filed: Jul. 11, 2017
(86) PCT No.: PCT/CA2017/050837

§ 371 Date: Sep. 13, 2018

Related U.S. Application Data
(63) Continuation-in-part of application No. PCT/CA2016/050809, filed on Jul. 11, 2016.
Application No. PCT/CA2016/050809 is a continuation-in-part of application No. PCT/CA2016/050710, filed on Jun. 17, 2016.
Application No. PCT/CA2017/050837 is a continuation-in-part of application No. PCT/CA2017/050285, filed on Mar. 2, 2017.
Application No. PCT/CA2017/050285 is a continuation-in-part of application No. PCT/CA2016/050809, filed on Jul. 11, 2016.
Application No. PCT/CA2016/050809 is a continuation-in-part of application No. PCT/CA2016/050710, filed on Jun. 17, 2016.
Application No. PCT/CA2017/050837 is a continuation-in-part of application No. PCT/CA2017/050740, filed on Jun. 16, 2017.
Application No. PCT/CA2017/050740 is a continuation-in-part of application No. PCT/CA2017/050285, filed on Mar. 2, 2017.
Application No. PCT/CA2017/050285 is a continuation-in-part of application No. PCT/CA2016/050710, filed on Jun. 17, 2016.
Application No. PCT/CA2016/050710 is a continuation-in-part of application No. PCT/CA2016/050809, filed on Jul. 1, 2016.
(60) Provisional application No. 62/474,012, filed on Mar. 20, 2017.
(60) Provisional application No. 62/323,031, filed on Apr. 15, 2016.
(60) Provisional application No. 62/323,031, filed on Apr. 15, 2016.

(30) Foreign Application Priority Data
Jul. 11, 2016 (CA) PCT/CA2016/050809
Mar. 2, 2017 (CA) PCT/CA2017/050285
Jun. 16, 2017 (CA) PCT/CA2017/050740

(51) Int. Cl. G06F 3/033; G06F 1/26; G06F 21/83

(52) U.S. Cl. CPC G06F 3/033; G06F 21/83; G06F 1/266

(57) ABSTRACT

A pointer relay device for a handheld or tablet computer having at least one data interface port and an operating system configured to interact with a user via a touch screen interface, and a keyboard interface accepting HID commands and without an interface to an external pointer device. The pointer relay device has a wired interface for connecting to said data interface port; a pointer device interface; and a controller configured to send commands using said interface port to enable cursor movement control via HID commands, receive pointer device movement signals and pointer button signals from said pointer device interface, and send HID commands causing cursor movement and pointer selection corresponding to said pointer device movement signals and pointer button signals.

The present application is a continuation-in-part of international application No. PCT/CA2016/050809 filed on Jul. 11, 2016, now pending, that is a continuation-in-part of international application No PCT/CA2016/050710 filed on Jun. 17, 2016, now abandoned; is a continuation-in-part of international application No PCT/CA2017/050740 filed on Jun. 16, 2017 that is a continuation-in-part of international application No PCT/CA2017/050285 filed on Mar. 2, 2017, now pending, that claims priority of U.S. provisional No. 62/323,031 filed on Apr. 15, 2016; and claims priority of U.S. provisional application No. 62/474,012 filed on Mar. 20, 2017.

### TECHNICAL FIELD

The present application relates to the field of computer device interfaces and, more specifically, to devices configured to allow a pointer device to interact with a computing device without an interface for that pointer device.

### BACKGROUND

Certain handheld devices or tablet devices do not provide an interface for permitting a user to use a mouse to interact with the computing device, as the computing device is designed to receive input as gestures made on a touchscreen, and not the motions and clicks of a mouse translated to cursor movements on a screen.

These computing devices lack an interface for the pointer device for receiving input information from the pointer device. Such computing devices include Apple's iOS devices (e.g. iPad® and iPhone®). However, as tablet users may frequently utilize their computing device as a portable device to the likes of a laptop, it would be advantageous to have a means for allowing a mouse to interact with the computing device, as using a mouse to control the computing device may be privileged in a work setting over tactile input for performing certain tasks.

Moreover, providing for a means of connecting certain peripheral devices to a computing device without an interface for those peripheral devices may allow for the connecting of specialized peripherals, such as those used by users afflicted with a specific handicap who have difficulty using the computing device by performing touch-related gestures to control the device.

A device that would allow the communicating of these peripheral devices, such as a mouse, with a computing device with an interface for that peripheral device, would be advantageous.

### SUMMARY

Applicant has discovered that using an external relay device (or defined herein as “relay device”), connected to a pointer device, as a pointer interface for a computing device that, or else, does not have an interface for the pointer device, allows for the computing device to receive cursor movement information from the pointer device. The external relay device would be connected to the computing device and to the pointer device. This cursor movement information may be translated by the relay device into HID commands that may be understood by the OS of the computing device for generating the cursor on the computing device's screen, moving the cursor across the screen, and clicking with the cursor on the screen at a desired location, all as a function of input provided by the pointer device to the relay device.

A first broad aspect is a pointer relay device for a handheld or tablet computer having at least one data interface port and an operating system configured to interact with a user via a touch screen interface, a keyboard interface accepting HID commands and without an interface to an external pointer device. The pointer relay device has an interface for connecting to the data interface port. The pointer relay device has a pointer device interface configured to establish a connection with a pointer device and receive pointer device movement signals and pointer button signals from the pointer device via the connection. The pointer relay device has a controller configured to send commands using the data interface port to enable cursor movement control via HID commands, receive the pointer device movement signals and the pointer button signals from the pointer device interface, and send HID commands causing cursor movement and pointer selection corresponding to the pointer device movement signals and the pointer button signals.

In some embodiments, the interface for connecting to the data interface port may be a wired interface. The data interface port may be configured to accept external power for powering the handheld or tablet computer, and the pointer relay device may be further configured to provide power to the handheld or tablet computer via the external keyboard interface. The interface for connecting to the data interface port may be a wireless interface. The connection between the pointer device interface and the pointer device may be wired. The wired connection between the pointer device interface and the pointer device may be a USB bridge. The connection between the pointer device interface and the pointer device may be wireless. The wireless connection between the pointer device interface and the pointer device may be a Bluetooth connection.

In some embodiments, the pointer relay device may have a battery. The pointer relay device may have an authentication chip to authenticate the pointer device. The authentication chip may be comprised in the interface for connecting to the data interface port.

In some embodiments, the HID commands may be configured to be processed by an application program of the handheld or tablet computer that generates a cursor on the display of the handheld or tablet computer. In some embodiments, the controller may be further configured to send at least one keyboard command that causes the launch of the application program running on the computer that generates a cursor on the display.

In some embodiments, the pointer relay device may have an additional pointer device interface configured to establish a connection with an additional pointer device and receive pointer device movement signals and pointer button signals from the additional pointer device via the connection.

In some embodiments, the pointer device interface may be further configured to establish a second connection with an additional pointer device and receive pointer device movement signals and pointer button signals from the additional pointer device via the second connection.

In some embodiment, the interface for connecting to the data interface port may be further configured to be connected to a multiport adapter.

A second broad aspect is a method for performing cursor movement and pointer selection on a display of a handheld or tablet computer. The method includes sending HID commands to a data interface port of the handheld or tablet computer for causing cursor movement and pointer selection on the display corresponding to pointer device movement signals and pointer button signals of a pointer device.

In some embodiments, the method may involve, prior to the sending, authenticating the pointer device. The method may involve, prior to the sending, converting the pointer device movement signals and point button signals into corresponding HID commands.

In some embodiments, the HID commands that are sent may be configured to be processed by an application program of the handheld or tablet computer that generates a cursor on the display of the handheld or tablet computer.

In some embodiments, the method may further include sending at least one keyboard command to launch the application program that generates a cursor on the display. The method may further involve mirroring the display on an external screen connected to the handheld or tablet computer, wherein the pointer selection and cursor movement may be apparent on the external screen.

### BRIEF DESCRIPTION OF THE DRAWINGS

The invention will be better understood by way of the following detailed description of embodiments of the invention with reference to the appended drawings, in which:

FIG. 1 is a block diagram of an exemplary relay device connected to an exemplary computing device and an exemplary pointer device, where the connection between the relay device and the computing device is established via a connector port.

FIG. 2 is a block diagram of an exemplary relay device connected to an exemplary computing device and an exemplary pointer device, where the connection between the relay device and the computing device is wireless.

FIG. 3 is a block diagram of an exemplary relay device connected to an exemplary computing device and an exemplary keyboard.

FIG. 4A is a flowchart diagram of an exemplary method for enabling a cursor on an iOS computing device and moving the cursor across the screen of the iOS computing device using the AssistiveTouch™ application program.

FIG. 4B is a flowchart diagram of an exemplary method for translating a click or press of a button of a pointer device into HID commands and processing the HID commands by the iOS computing device.

FIG. 5A is an exemplary block diagram of a relay device connected to a computing device where the computing device mirrors its screen with an external screen via a multiport adaptor.

FIG. 5B is an exemplary block diagram of a relay device connected to a computing device where the computing device mirrors its screen with an external screen by establishing a wireless connection with an external server.

### DETAILED DESCRIPTION

Certain handheld devices or tablet devices do not allow an external pointer device (e.g. a mouse) to interact with the device as they do not have an interface for a mouse or the external pointer device. Such handheld devices or tablet devices are, for instance, those running an iOS (e.g. iPhone® and the iPad®). This is an inconvenience for users who desire to use a mouse to navigate and control their handheld or tablet device. The present application provides a relay device that serves as an interface between a peripheral device, such as an external pointer device, and the handheld or tablet device that does not have an interface for the external pointer device. The relay device then translates the input received by the peripheral device into HID commands that are sent to the handheld or tablet device to enable cursor movement and pointer button signals (the clicking or pressing of the buttons on the pointer device).

In the present application, a “computing device” is defined as a handheld computer or tablet computer with at least one data interface port, an operating system configured to interact with a user via a touch screen interface, and a keyboard interface accepting control key commands. The computing device, as defined herein, does not have an interface to an external pointer device (e.g. a mouse). Again, exemplary computing devices may be those running on iOS such as, for instance, the iPhone® and the iPad®.

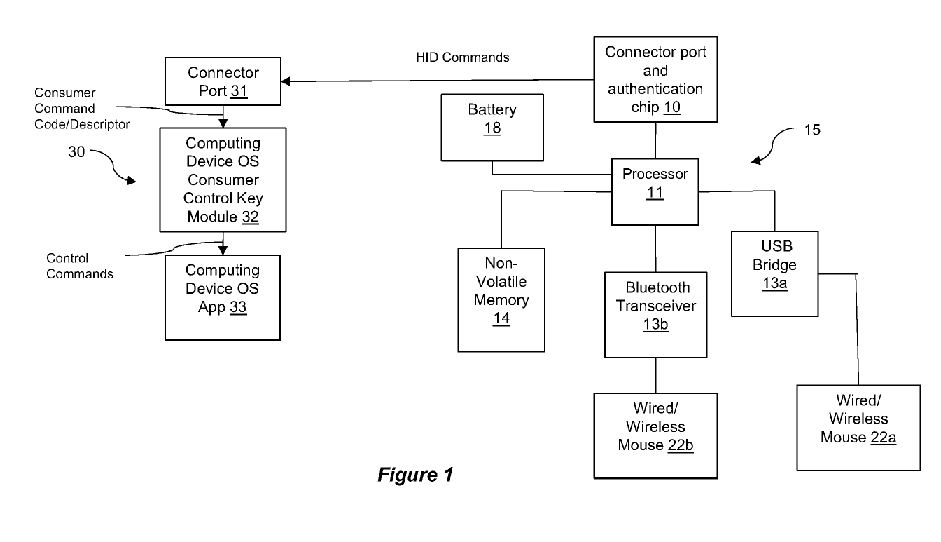

Reference is now made to FIG. 1, illustrating an exemplary relay device 15 interacting with an exemplary computing device 30 for allowing for the interaction between a pointer device (e.g. a mouse) and the computing device 30.

The computing device has, for instance, computing device OS consumer control key module 32 that represents part of the computing device's 30 operating system that processes wireless keyboard commands and allows such commands as those to launch application programs or apps, enter text or make certain selections on the device. In the case of the Apple iPhone® or iPad®, keyboard commands can be used to perform actions that normally are associated with the device's touch screen actions or buttons, as for example, the swipe action to initiate unlocking a locked phone, the pressing of the home button, volume control, etc. Likewise, running a desired app can be implemented by using a keyboard command to initiate a search or find on the smartphone, and then sending keystrokes of the name of the app on the computing device 30 will cause the desired app 33 to be found, with another keystroke, such as ENTER. Keyboard commands may be used to activate certain application programs such as AssistiveTouch™.

A HID command is defined herein as a command sent by the relay device, processed by the OS of the computing device, that is related to input received by a human interface device (i.e. a peripheral device), such as a mouse, keyboard and joystick. Similarly to the keyboard commands, the HID commands may be processed by the computing device OS consumer control key module 32 that represents part of the computing device's 30. The input from the peripheral device is processed by the relay device to generate the HID commands, which may include HID reports related to the input from the peripheral device. The HID command, and the HID report(s) tied to the HID command, as defined herein, are not limited to a specific protocol or given standard such as the HID standard.

An example of a keyboard command that simulates a press on touch screen can be as follows:

Enable assistive touch
/* HID map descriptor */
const unsigned char startHidMouseMessage[ ] =
{

/* param 1 HIDComponentIdentifier*/
0x00,0x06, /* length */
0x00,0x00, /* ID */
0x00,0x00,
/* param 2 vendorIdentifer */
0x00,0x06, /* length */
0x00,0x01, /* ID */
0x04,0x61,
/* param 3 productIdentifier */
0x00,0x06, /* length */
0x00,0x02, /* ID */
0x00,0x00,
/* param 4 HID report descriptor */
0x00,0x36, /* length */
0x00,0x04, /* ID */
0x05 ,0x01,
0x09 ,0x02,
0xa1 ,0x01,
0x09 ,0x01,
0xa1 ,0x00,
0x05 ,0x09,
0x19 ,0x01,
0x29 ,0x03,
0x15 ,0x00,
0x25 ,0x01,
0x95 ,0x03,
0x75 ,0x01,
0x81 ,0x02,
0x95 ,0x01,
0x75 ,0x05,
0x81 ,0x01,
0x05 ,0x01,
0x09 ,0x30,
0x09 ,0x31,
0x15 ,0x81,
0x25 ,0x7f,
0x75 ,0x08,
0x95 ,0x02,
0x81 ,0x06,
0xc0 ,
0xc0

};
ISPP_Send_Control_Message(BluetoothStackID,
SerialPortID,0x5400,0,NULL); //start assistivetouch

ISPP_Send_Control_Message(BluetoothStackID,

| | |
|---|---|
| SerialPortID,0x6800,sizeof(startHidMouseMessage),(unsigned | char |

*)startHidMouseMessage);
To simulate the screen press:
unsigned char mouseCmd[ ] =
{

/* param 1 HIDComponentIdentifier*/
0x00,0x06, /* length */
0x00,0x00, /* ID */
0x00,0x00,
/* param 2 vendorIdentifer */
0x00,0x07, /* length */
0x00,0x01, /* ID */
0x01,0x00,0x00

};
ISPP_Send_Control_Message(BluetoothStackID,
SerialPortID,0x6802,sizeof(mouseCmd),mouseCmd);

It will be understood that the keyboard commands used to cause the smartphone to perform certain tasks, and as well the HID commands related to input received from a peripheral device, such as its unlocking or running a designated application, depends on the platform of the smartphone. The sequence of keyboard commands also depends upon the task to be carried out. Therefore, a skilled person will readily understand that a desired sequence of keyboard commands, or a desired HID command, for a specific platform may be determined using basic trial and observation, where the effect of receiving a specific sequence of keyboard commands (and HID commands) by the smartphone is monitored for the desired action.

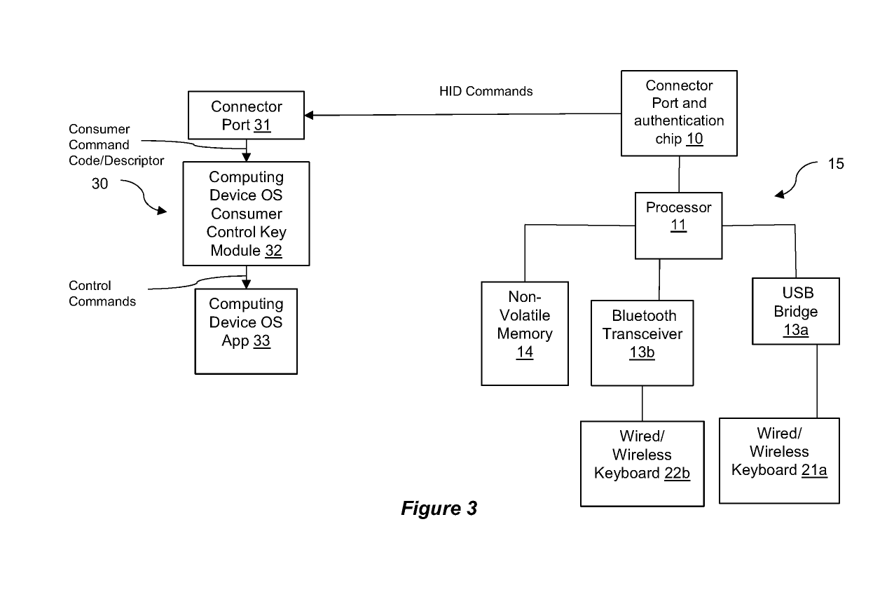

In the example of FIG. 1, the relay device 15 communicates with a peripheral device, where the peripheral device is a mouse 22a. The peripheral may be, for instance, a wired or wireless mouse 22a, or a wired or wireless keyboard 21, as shown in FIG. 3. The peripheral may also be, for example, a joystick, a video game remote or game control, or a motion sensing device for detecting, for instance, a user's movements (not shown). The skilled person will understand that the peripheral may be any other device that receives user input that may be transmitted to the computing device 30 via the relay device 15 without departing from the present teachings. Furthermore, there may be, one, two, three or more peripheral devices connected to one relay device 15.

Exemplary input from a mouse (e.g. mouse 22a or mouse 22b) may be, for example, the movement of the pointer, or pointer button input such as, a click or press of the left button, a click or press of the right button, a “double-click” or “double-press” of the left button, or one click (or selection) or multiple clicks (or selections) of a button of the cursor. Exemplary input from a keyboard (e.g. keyboard 21a or keyboard 21b) may be a keystroke or a combination of keystrokes such as “ctrl+c” or “ctrl+z”. Such keystrokes may also include, for example, increasing or lowering the volume of the device, or the brightness of a screen.

The embodiment of FIG. 1 shows a relay device 15 wired or wirelessly connected to a mouse 22a. The relay device 15 has a USB bridge 13a for connecting to a peripheral device, such as mouse 22a, non-volatile memory 14, a processor 11, and a connector port (with optionally an authentication chip) 10. The relay device 15 may also have a Bluetooth transceiver 13b for establishing a wireless, bandwidth limited, connection with a peripheral device, such as wired/wireless mouse 22b. In some embodiments, the relay device 15 may have a battery 18.

The relay device 15 may be used to process input from a peripheral device (e.g. mouse 22a) used by a local user to HID commands then processed by the local user's computing device 30. The mouse 22a, connected to a USB bridge 13a, transmits input, such as cursor movement information, or mouse click information, to the relay device 15 via its USB Bridge 13a.

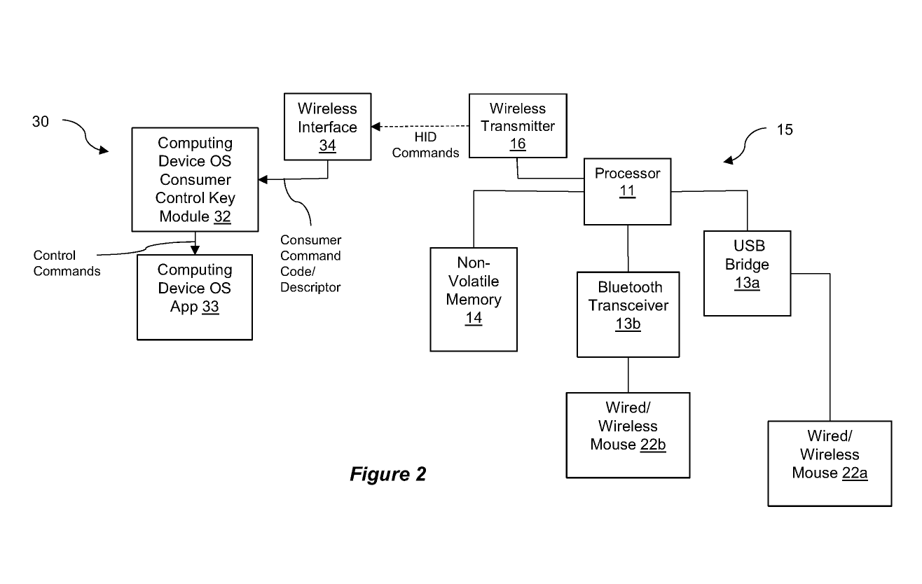

The USB Bridge 13a (and/or the Bluetooth transceiver 13b) sends the input information from the mouse 22a (or mouse 22b) to the processor 11, such as movement signals and mouse button signals) that may use information on the configuration of the mouse 22a or 22b, or a set of translation settings for translating the input received from the mouse 22a or 22b into HID commands that are understood by the OS of the computing device 30, this information and/or configurations received by and/or stored in memory 14. The processor 11 then implements instructions, stored in memory 14, on converting the input into HID commands as a function of peripheral layout or configuration stored in memory 14. Processor 11 may be, e.g., a micro-processor. The HID commands may then be sent via a link, or wired link, between the relay device's 15 connector port 10 and the connector port 31 of the computing device 31. In some embodiments, as shown in FIG. 2, the HID commands may be sent via the wireless transmitter 16 of the relay device 15 to the wireless interface 34 of the computing device 30. The wireless interface 34 may be a Bluetooth interface, for receiving the HID commands via a Bluetooth connection.

Once received, the computing device 30 carries out the desired action in correspondence with the HID commands, the tablet computer OS consumer control key module 32 receiving consumer control key code and/or descriptors, such as the HID relative pointer position reports, from the connector port 31 or the wireless interface 34. The computer OS consumer control key module 32 then sends the control commands or instructions to a target computer OS app 33 so they are carried out by the computer OS app 33. In the case where the peripheral device is a mouse, the target computer OS app 33 may be a program that allows for the appearance of the cursor, or for the motion of the cursor across the screen, as is described herein.

The computing device 30 may also send command settings relating to the keyboard 21a or 21b, or mouse 22a or 22b to the relay device 15 via, for example, a Bluetooth connection established between the computing device 30 and relay device 15. These command settings may then be stored in the non-volatile memory 14.

In some embodiments, the connector port 10 may also have an authentication chip 12 (e.g. MFi authentication chip for Apple™'s MFi Program), as is known in the art, for authenticating the peripheral device that is to communicate with the computing device 30 via the relay device 15. In other embodiments, the relay device 15 may have an authentication system for carrying out authentication protocols, such as one at least in part stored in memory 14 (e.g. in the case of software key authentication), in order to authenticate the peripheral device that is to be connected to the computing device 30 via the relay device 15.

In some embodiments, the HID commands sent by the relay device 15 may be specifically tailored to interact with the application program AssistiveTouch™ of an iOS device. AssistiveTouch™ is an application program for assisting a user in the controlling of the iOS device, such as in the performance of certain gestures (e.g. pinch, multi-finger swipe) and providing a shortcut for accessing certain features of the iOS device (e.g. the Control Center, Siri). Once the AssistiveTouch™ application program is activated as is described herein, AssistiveTouch™ may be configured in such a way that a cursor appears on the screen of the iOS device. Input from the peripheral device is converted into HID commands by the relay device 15, and these commands are sent to the iOS device by the relay device 15 and processed into commands of the cursor on the iOS device's screen, such as movements of the cursor, clicking on the screen or swiping across the screen. For example, where the peripheral device is a mouse 22a or 22b, the movement of the mouse 22a or 22b is converted into HID commands, the cursor replicating on the screen the movements of mouse 22a or 22b. In another example, when the peripheral device is a trackpad, the trackpad senses the movement and touch of, for example, a user's finger on its surface, and this input is sent to and converted into HID commands by the relay device 15, for operating the cursor appearing on the iOS device's screen, such as by moving, clicking or swiping of the cursor on the screen of the iOS device, these actions equivalent to the input received from the touchpad. The peripheral device, the relay device 15 and the Bluetooth connection between the peripheral device and the iOS device and/or between the relay device 15 and the iOS device may be MFi enabled (the MFi program is a licensing program run by Apple where hardware and software peripherals are enabled to run with Apple™ products, such as the iPhone and iPad). Furthermore, the relay device 15 may be part of the peripheral device. These illustrations are not limitative and are but examples of how the AssistiveTouch™ application program may be used in accordance with teachings of the present invention.

In one example, where the computing device 30 is an iOS device (where the OS is e.g. iOS 6 to iOS 10) the relay device 15 may transmit commands that are to be performed by the Switch Control™ application program of the iOS device. Switch Control™ is a program allowing a user to control the iOS device using certain input, such as a Bluetooth switch, tactile input registered by the device's screen, or a head motion registered by the device's camera. A first input allows the user to select a location on a screen, and a second subsequent input allows the user to choose an action (e.g. clicking on icon on a screen, swiping, etc.). The relay device 15 may transmit keyboard commands to activate Switch Control™ and then send keyboard commands to carry out certain actions using Switch Control™. For example, Switch Control™ may be useful for selecting an application on the screen, mimicking the tap of a finger. The Switch Control™ may be configured so that the relay device 15, following the reception of user input to select an application icon, would send keyboard commands, processed by the iOS device's iOS, to activate a first switch control of Switch Control™ to bring up the “HOME” page on the iOS device. Then, the relay device 15 may send keyboard commands to activate a second switch control to select the application icon. The second switch control may be, for instance, using Switch Control™'s item scanning feature, swoop scanning feature or manual scanning feature to identify the application icon with a sufficient time delay as required by the Switch Control™ application program, then do a timed selection of the application icon as permitted with Switch Control™. For example, once manual scanning is enabled, and using an external accessory for providing external input to the Switch Control™ enabled device, with knowledge of the layout of the home screen of the computing device, it is possible to use Switch Control™ to navigate through the applications on the home screen and perform, for instance, the selection of a desired application program.

The relay device 15 may be, for example, a standalone dongle. In other examples, the relay device may be hardware integrated into the peripheral (e.g. the keyboard, the mouse). For example, each peripheral device may have its own relay device communicating with the computing device 30 or multiple computing devices 30 (e.g. useful in a class setting).

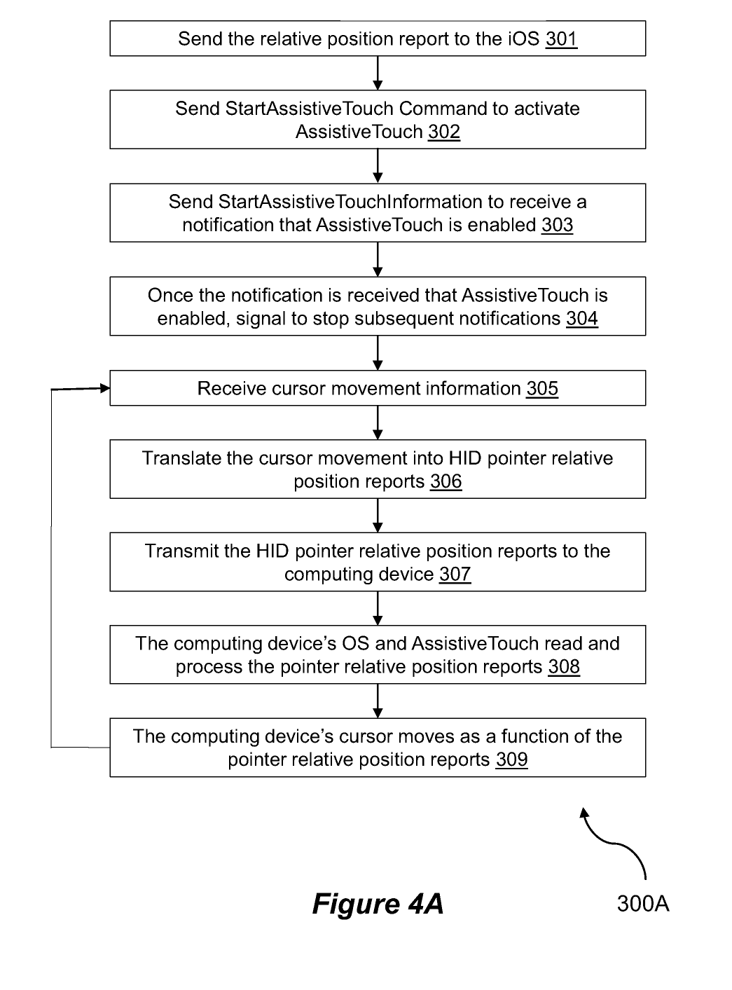

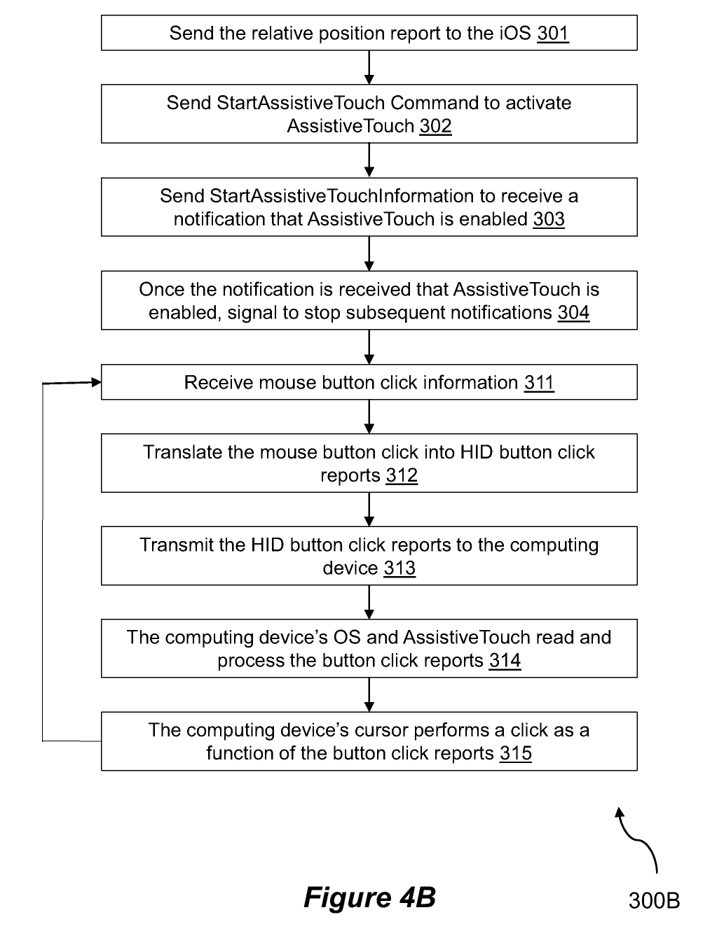

Reference is now made to FIG. 4A, showing a flowchart diagram of an exemplary method 300A of causing cursor movement, as a function of input received by the relay device from an external pointer device, on the screen of an iOS computing device, using the application program AssistiveTouch™ of an iOS device.

A report of the relative position or pointer movement of the pointer device is sent to the iOS computing device via the relay device at step 301. The relay device translates the cursor movement information into HID commands relating to the relative position report of the pointer device. Then, the relay device transmits a keyboard command, “StartAssistiveTouch” Command, to the iOS computing device (e.g. via the connector port, or via a wireless connection) to initiate AssistiveTouch™ at step 302. Enabling AssistiveTouch™ prompts the appearance of a cursor on the touchscreen of the iOS computing device. A StartAssistiveTouchInformation command is then sent by the relay device to the iOS computing device (e.g. via the connector port, or via a wireless connection), the StartAssistiveTouchInformation command processed by the iOS and AssistiveTouch™ to generate a notification that AssistiveTouch™ is enabled at step 303. Once the notification that AssistiveTouch™ is enabled has been received by the relay device, where the notification is sent from the iOS computing device using, for instance, Apple™'s iAP2 protocol (where the relay device supports an iAP2 protocol), then a keyboard command is sent by the relay device to the iOS computing device to stop generating AssistiveTouch™ notifications at step 304 (e.g. via the connector port, or via a wireless connection).

As AssistiveTouch™ is enabled and a notification to this effect has been received, the relay device continues to receive cursor movement information from the pointer device, describing the motions and displacements of the pointer device at step 305. The cursor movement information may be received, for instance, via a USB bridge or a wireless Bluetooth interface of the relay device. The cursor movement information is then processed by the relay device into HID commands relating to HID pointer relative position reports at step 306, generated, for instance, from the pointer device configuration settings and processing instructions stored as software in the relay device's memory. An example of a mouse relative position report, that may be part of an HID command, is:

unsigned char mouseCmd[ ] =
{

| /* param 1 HIDComponentIdentifier*/ | |
|---|---|
| 0x00,0x06, | /* length */ |
| 0x00,0x00, /* ID */ | |
| 0x00,0x00, | |
| /* param 2 vendorIdentifer */ | |
| 0x00,0x07, | /* length */ |

0x00,0x01, /* ID */
0x00,0x02,0x05 /* Move to x, y as 2,5 */

The HID commands relating to the HID pointer relative position reports are then transmitted using, for instance, a connector port (e.g. lightening port) via, for instance, a wired connection, to the connector port of the iOS computing device at step 307. In some examples, the HID commands relating to the HID pointer relative position reports may be transmitted to the iOS computing device via a wireless interface, such as a Bluetooth interface. However, using the bandwidth limited Bluetooth connection to transmit the HID commands may result in a jittery cursor movement across the screen of the iOS computing device. However, other versions of Bluetooth or any other wireless connection may provide sufficient responsiveness to achieve fluid cursor movement across the screen. In some examples, power may also be provided to the computing device via the connector port (e.g. lightning port) from the pointer relay device.

The computing device then processes and reads the HID commands relating to the HID pointer relative position reports and sends instructions to the AssistiveTouch™ Program as a function of the HID pointer relative position reports at step 308. The AssistiveTouch™ Program then carries out the instructions and moves the cursor on the screen as a function of the HID pointer relative position reports at step 309, the movement of the cursor corresponding to the movement of the pointer device.

Steps 305 and 309 are carried out periodically after given time intervals, in order to punctually provide information as the movement of the cursor that is translated by the relay device and then processed by the computing device's iOS, in order for the cursor's position to be regularly updated as a function of the pointer device's position, and also to allow for a smoother movement of the cursor on the screen of the iOS computing device. In one embodiment, steps 305 through 309 are carried out at 10 millisecond intervals where the cursor movement information is equally received and HID commands are provided on moving the cursor every 10 milliseconds (it will be appreciated that the 10 millisecond intervals are but an example time between different intervals and that the time intervals between each sequence of steps 305 and 309 may be other than (less or more) than 10 milliseconds without departing from the present teachings). Furthermore, a smoothing algorithm may be applied on cursor movement in order to provide for a smoother cursor movement when the pointer device undergoes a significant change in position. In one example, the smoothing algorithm may divide the relative position change of the pointer device, as provided in the cursor movement information, by a predefined factor.

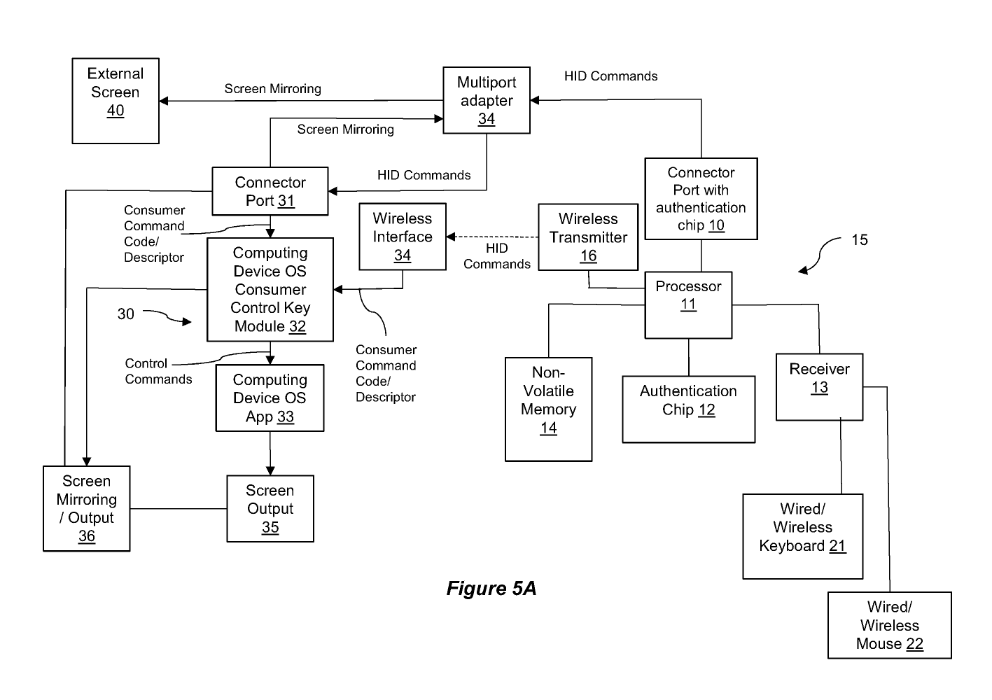

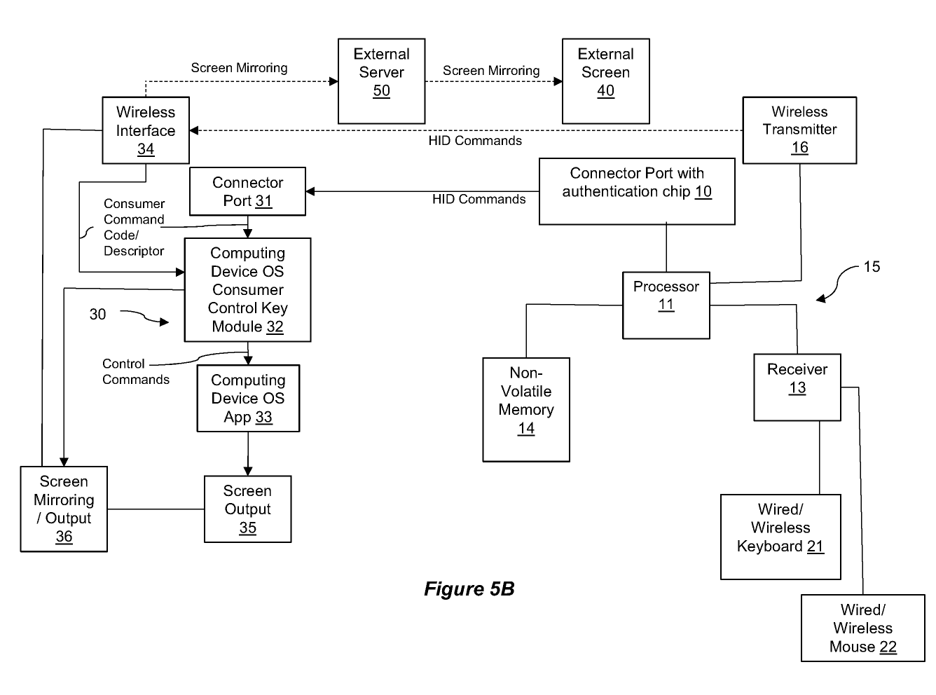

Reference is now made to FIG. 5B, a flowchart diagram of an exemplary method 300B of reproducing a cursor mouse click, as a function of input received by the relay device from an external pointer device, on the screen of an iOS computing device, using the application program AssistiveTouch™ of an iOS device.

Once AssistiveTouch™ is enabled, the cursor appearing on the screen of the computing device, and a notification to this effect has been received by the relay device, the relay device can also receive cursor click information from the pointer device, describing the click of a button of the cursor at step 311. The cursor click information may be received, for instance, via a USB bridge or a wireless Bluetooth interface of the relay device. The cursor click information is then processed by the relay device into HID commands relating to HID button click reports at step 312, generated, for instance, from the pointer device configuration settings and processing instructions stored as software in the relay device's memory.

The HID commands relating to the HID button click reports are then transmitted using, for instance, a connector port (e.g. lightening port) via, for instance, a wired connection, to the connector port of the iOS computing device at step 313. An exemplary HID button click report, that may be part of a HID command, is:

unsigned char mouseCmd[ ] =
{

| /* param 1 HIDComponentIdentifier*/ | |
|---|---|
| 0x00,0x06, | /* length */ |
| 0x00,0x00, /* ID */ | |
| 0x00,0x00, | |
| /* param 2 vendorIdentifer */ | |
| 0x00,0x07, | /* length */ |

0x00,0x01, /* ID */
0x01,0x00,0x00 /* 0x01 means button pressed down*/

};
then
unsigned char mouseCmd[ ] =
{

| /* param 1 HIDComponentIdentifier*/ | |
|---|---|
| 0x00,0x06, | /* length */ |
| 0x00,0x00, /* ID */ | |
| 0x00,0x00, | |
| /* param 2 vendorIdentifer */ | |
| 0x00,0x07, | /* length */ |

0x00,0x01, /* ID */
0x00,0x00,0x00 /* 0x00 means button released*/

};

In some examples, the HID commands relating to the HID button click reports may be transmitted to the iOS computing device via a wireless interface, such as a Bluetooth interface. However, using the bandwidth limited Bluetooth connection to transmit the HID commands may result in delayed cursor clicks as viewed on the display of the iOS computing device.

The computing device then processes and reads the HID commands relating to the HID button click reports and sends instructions to the AssistiveTouch™ as a function of the HID button click reports at step 314. The AssistiveTouch™ then carries out the instructions and performs the click(s) of the pointer on the screen as a function of the HID button click reports at step 315, the click of the pointer corresponding to the click of the button of the pointer device.

The mouse click reports and the carrying out of steps 311 to 315 may be performed periodically after given time intervals.

Reference is now made to FIG. 5A, illustrating an exemplary relay device 15 connected to a computing device 30 via a multiport adaptor 34 for providing screen mirroring on an external screen 40, where the external screen 40 is connected to the computing device 30 via the multiport adaptor 34.

The relay device 15 may receive peripheral information via its receiver 13 (e.g. USB bridge, or Bluetooth transceiver) from peripheral devices, such as wired/wireless keyboard 21 and/or wired/wireless mouse 22, and translate and transmit this information to computing device 30 as described herein.

The computing device 30 may also share its screen with the external screen 40 by utilizing its screen output information 35, for screen mirroring 36, the screen output information sent as data via the connector port 31 to the multiport adaptor 34, and later shared with the external screen 40 joined to computing device 30 via the multiport adaptor 34.

Moreover, in the example where the peripheral device is a wired/wireless mouse 22, the mirrored screen shown on the external screen 40 also displays the cursor, as the cursor appears and moves on the computing device's screen, by, for instance, following the steps described in FIG. 4A. Therefore, the movement of the cursor as a function of the cursor movement information received from the pointer device also appears on the external screen 40, as the image of the cursor as part of the screen image is transmitted as part of the data composing the screen output image shared during screen mirroring. The screen mirroring feature is one as is known in the art.

As shown in FIG. 5B, the screen mirroring may also occur wirelessly, where the screen image information is sent wirelessly, such as via a LAN network or WiFi connection, to an external server 50. The external server 50 then transmits the screen image information to the external screen 40. In one example, the external server 50 may be wired to the external screen 40, where the screen image information is transmitted via the wired connection to the external screen 40. In one example, the external server 50 may also establish a wireless connection with the external screen 40 (e.g. WiFi connection and/or via a LAN network), where the external server 50 transmits the screen image information to the external screen 40 via the wireless connection. An exemplary external server 50 is the Apple AirPort™ device, used to connect AirPort™-enabled computers to, for instance, the Internet, each other or a wired LAN network, enabling screen mirroring between the computing device 30 and the external screen 40. The screen mirroring of FIG. 5B may be implemented as is known in the art.

The description of the present invention has been presented for purposes of illustration but is not intended to be exhaustive or limited to the disclosed embodiments. Many modifications and variations will be apparent to those of ordinary skill in the art.

1. A pointer relay device for a handheld or tablet computer having at least one data interface port and an operating system configured to interact with a user via a touch screen interface, a keyboard interface accepting HID commands and without an interface to an external pointer device, said pointer relay device comprising:
an interface for connecting to said data interface port;
a pointer device interface configured to establish a connection with a pointer device and receive pointer device movement signals and pointer button signals from said pointer device via said connection; and
a controller configured to:
send commands using said data interface port to enable cursor movement control via HID commands;
receive said pointer device movement signals and said pointer button signals from said pointer device interface; and
send HID commands causing cursor movement and pointer selection corresponding to said pointer device movement signals and said pointer button signals.

2. The pointer relay device as defined in claim 1, wherein said interface for connecting to said data interface port is a wired interface.

3. The pointer relay device as defined in claim 2, wherein said data interface port is configured to accept external power for powering said handheld or tablet computer, and wherein said pointer relay device is further configured to provide power to said handheld or tablet computer via said external keyboard interface.

4. The pointer relay device as defined in claim 1, wherein said interface for connecting to said data interface port is a wireless interface.

5. The pointer relay device as defined in claim 1, wherein said connection between said pointer device interface and said pointer device is wired.

6. The pointer relay device as defined in claim 5, wherein said wired connection between said pointer device interface and said pointer device is a USB bridge.

7. The pointer relay device as defined in claim 1, wherein said connection between said pointer device interface and said pointer device is wireless.

8. The pointer relay device as defined in claim 7, wherein said wireless connection between said pointer device interface and said pointer device is a Bluetooth connection.

9. The pointer relay device as defined in claim 1, further comprising a battery.

10. The pointer relay device as defined in claim 1, further comprising an authentication chip to authenticate said pointer device.

11. The pointer relay device as defined in claim 10, wherein said authentication chip is comprised in said interface for connecting to said data interface port.

12. The pointer relay device as defined in claim 1, wherein said HID commands are configured to be processed by an application program of said handheld or tablet computer that generates a cursor on the display of said handheld or tablet computer.

13. The pointer relay device as defined in claim 12, wherein said controller is further configured to send at least one keyboard command that causes the launch of said application program running on said computer that generates a cursor on said display.

14. The pointer relay device as defined in claim 1, further comprising an additional pointer device interface configured to establish a connection with an additional pointer device and receive pointer device movement signals and pointer button signals from said additional pointer device via said connection.

15. The pointer relay device as defined in claim 1, wherein said pointer device interface is further configured to establish a second connection with an additional pointer device and receive pointer device movement signals and pointer button signals from said additional pointer device via said second connection.

16. (canceled)

17. A method for performing cursor movement and pointer selection on a display of a handheld or tablet computer, comprising sending HID commands to a data interface port of said handheld or tablet computer for causing cursor movement and pointer selection on said display corresponding to pointer device movement signals and pointer button signals of a pointer device.

18. The method of claim 17, further comprising, prior to said sending, authenticating said pointer device.

19. The method as defined in claim 17, further comprising, prior to said sending, converting said pointer device movement signals and point button signals into corresponding HID commands.

20. The method as defined in claim 17, wherein said HID commands that are sent are configured to be processed by an application program of said handheld or tablet computer that generates a cursor on said display of said handheld or tablet computer.

21. The method as defined in claim 20, further comprising sending at least one keyboard command to launch said application program that generates a cursor on said display.

22. (canceled)
